(19) United States
(12) Patent Application Publication
(10) Pub. No.: US 2006/0104426 A1
(43) Pub. Date: May 18, 2006

(54) Prepaid dating card system and method

(76) Inventor: John Michael Cataldi, Sugar Hill, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 11/273,298

(22) Filed: Nov. 14, 2005

Related U.S. Application Data
(60) Provisional application No. 60/627,416, filed on Nov. 12, 2004.
(60) Provisional application No. 60/627,417, filed on Nov. 12, 2004.

(51) Int. Cl. H04M 15/00

(52) U.S. Cl. 379/114.2; 379/114.01

(57) ABSTRACT

A prepaid dating card system and method allowing a user to buy prepaid blocks of memberships, searches and other tools within online dating services. The systems and methods thereby allow a user to anonymously purchase prepaid funds on a card and subsequently use those funds for a series of online dating options.

Priority based on U.S. Provisional Patent Application, Ser. No. 60/627,416, filed Nov. 12, 2004, and entitled “Prepaid Dating Card”, and U.S. Provisional Patent Application, Ser. No. 60/627,417, filed Nov. 12, 2004, and entitled “Agency Content Management Personalization Wizard”, is claimed.

### BACKGROUND

I. Field of the Invention

The present invention relates generally to the field of prepaid services and more particularly to a prepaid dating card system and method.

II. Description of the Related Art

The prepaid market is rapidly expanding into new market niches. For example, prepaid phone cards and debit cards are commonplace in today's marketplace. For the unbanked markets defined as those individuals unable to pay by credit card are estimated at 28% of Americans who do not have a bank account and 54% who are within 5% of their upper card limit, and this have limited spending ability. Prepaid cards act as an alternative means to transfer their cash assets onto a restored value card/gift card format to make in-store, online or phone purchases. For both banked and un-banked clients alike, prepaid cards maintain the user's privacy and anonymity while purchasing any product or service thereby reducing the risk of identity theft and the like. For the merchant, prepaid cards reduce the rate of charge backs and product fraud, since most prepaid cards are purchased in physical store locations with cash thereby reducing the merchants' exposure to credit card fraud via consumer identity theft.

Furthermore, online, mobile and phone dating service have become increasingly popular in today's society in which many demands are placed on a person's life, thereby leaving little time for people to seek dates in more traditional ways. However, many online dating services, like most online services, require that credit cards and personal information be disclosed in order to join the services. Although there are many safeguards currently in place to protect the identity and personal information of individuals, the nature of online dating typically further adds the desire to potentially retain anonymity online.

### SUMMARY

In general, the invention features a prepaid dating card system and method allowing a user to buy prepaid blocks of memberships, searches and other tools within online dating services. Prepaid blocks can also be purchased for a variety of other services including but not limited to interactive voice response (IVR), mobile including short message service (SMS) and multimedia messaging system (MMS), as well as physical based membership. The systems and methods thereby allow a user to anonymously purchase prepaid funds on a card and subsequently use those funds for a series of online dating options. In a typical embodiment, a stored-value card is distributed to a merchant for distribution to a customer who has an account with a specific provider of goods and/or services. The stored value card has an associated identifier that can be used to associate a stored value with the card. The associated stored value is redeemable with one or more providers, including the specific provider. The account has an associated account number. During a card purchase transaction, a central processor receives a request to activate the card from a merchant terminal. The central processor receives a redemption request from the customer, wherein the redemption request includes the identifier. The central processor identifies the provider and the account number. The central processor inserts the associated value into the account for instance by passing a value insertion request to the provider. The central processor receives a subsequent request to activate the card from a different merchant terminal. The central processor recognizes the card, identifies the provider and account number, and automatically inserts the value into the account.

In general, in one aspect, the invention features a prepaid dating system, including a central server connected to a network, at least one dating service provider connected to the network, at least one merchant terminal connected to the network, a prepaid dating card for interacting with the at least one merchant terminal to receive a value insertion from the at least one merchant terminal, and for interacting with the at least one dating service provider that extracts value from the prepaid dating card in return for dating services provided by the at least one dating service provider.

In one implementation, the dating service provider is a web portal developed from a modular site design system, including a plurality of design modules, an interface for selecting a subset of the design modules of the plurality to be included in an electronic presence, the selected design modules forming a package of design modules, means for forwarding the package of design modules to a the application service provider platform and deployment onto a electronic medium and means for accepting the prepaid dating card as payment for access to the web portal.

In another implementation, the dating service provider is a web portal including an interface formed by a design module, membership database inclusions in the interface from which individual members can choose, database filters created by individual users of the web portal to select users of interest based on pre-selected criteria and a payment option for membership to the web portal.

In another implementation, the payment option is the prepaid dating card.

In another implementation, the web portal further comprises inclusions of various product service offerings from a plurality of design modules at a graphic user interface.

In yet another implementation, the web portal resides on an application service provider platform for electronic publishing, thereby advertising a payment option using the prepaid dating card.

In still another implementation, the system further includes a plurality of linked modules creating an electronic presence, the linked modules all for receiving payment from the prepaid dating card as a form of payment for access to the modules.

In another implementation, the dating service provider is one of the plurality of linked modules.

In another implementation, the modules can be updated by forwarding an updated version of one of the modules to an application service provider using one of the modules, storing, at the application service provider, the updated version of the one of the modules, replacing, in a directory structure at the application service provider, a first pointer to an existing version of the one of the modules with a second pointer to the updated version of the one of the modules.

In another implementation, data related to the prepaid dating card can be updated in one or more of the plurality of modules.

In another implementation, data related to the prepaid dating card is value inserted into the prepaid dating card.

In another aspect, the invention features data residing on a readable medium capable of receiving instructions including receiving and retaining payment data, providing the payment data to a central location, associating the payment data with pre-selected dating-related services and reducing the payment data based on usage of the payment data related to the dating-related services.

In one implementation, the readable medium is a bar code and UPS.

In another implementation, the readable medium is magnetic media.

In another aspect, the invention features an article of manufacture, including a main body and a readable medium on the main body, the readable medium having data related to pre-payment of funds to be used for dating services.

In one implementation, the readable medium is a magnetic strip.

In another implementation, the readable medium is a bar code and UPS.

The embodiments described herein can also be implemented on smart cards.

One advantage of the invention is that it allows the procurement of dating services without using a standard credit card, thereby limiting security risks.

Another advantage of the invention is that the systems and methods allow the user to retain personal information, thereby reducing the need to disclose personal information to undesirable other users of the dating services.

Another advantage of the invention is that it allows a “pay as you go” approach for dating services.

Another advantage of the invention is that it increases privacy and allows the user to use the product/service anonymously.

Other objects, advantages and capabilities of the invention will become apparent from the following description taken in conjunction with the accompanying drawings showing the preferred embodiment of the invention.

### BRIEF DESCRIPTION OF THE DRAWINGS

FIG. 1 illustrates an embodiment of a prepaid dating system for a user to purchase and activate prepaid dating cards;

FIG. 2 illustrates an embodiment of a network diagram provided to illustrate communication links between a application service provider and a client seeking to use the site design system and method of the present invention;

FIG. 3 illustrates an embodiment of a block diagram showing exemplary components that may be included at the application service provider to provide site component package according to the present invention;

FIG. 4 illustrates an embodiment of a flow diagram illustrating exemplary steps that may be performed at the application service provider to generate the web site component package of FIG. 3;

FIG. 5 illustrates an embodiment of a block diagram illustrating exemplary components that display the output created by the application service provider; and

FIG. 6 illustrates an embodiment of a block diagram illustrating exemplary components that display work flow to an IVR or SMS service.

### DETAILED DESCRIPTION

In general, embodiments of a prepaid dating card system and method allow a user to buy prepaid blocks of memberships, searches and other tools within online dating services, as well as other methods such as IVR, MMS, SMS and the like. The systems and methods thereby allow a user to anonymously purchase prepaid funds on a card and subsequently use those funds for a series of online dating options. In a typical embodiment, a stored-value card is distributed to a merchant for distribution to a customer who has an account with a specific provider of goods and/or services. The stored value card has an associated identifier that can be used to associate a stored value with the card. The associated stored value is redeemable with one or more providers, including the specific provider. The account has an associated account number. During a card purchase transaction, a central processor receives a request to activate the card from a merchant terminal. The central processor receives a redemption request from the customer, wherein the redemption request includes the identifier. The central processor identifies the provider and the account number. The central processor inserts the associated value into the account for instance by passing a value insertion request to the provider. The central processor receives a subsequent request to activate the card from a different merchant terminal. The central processor recognizes the card, identifies the provider and account number, and automatically inserts the value into the account.

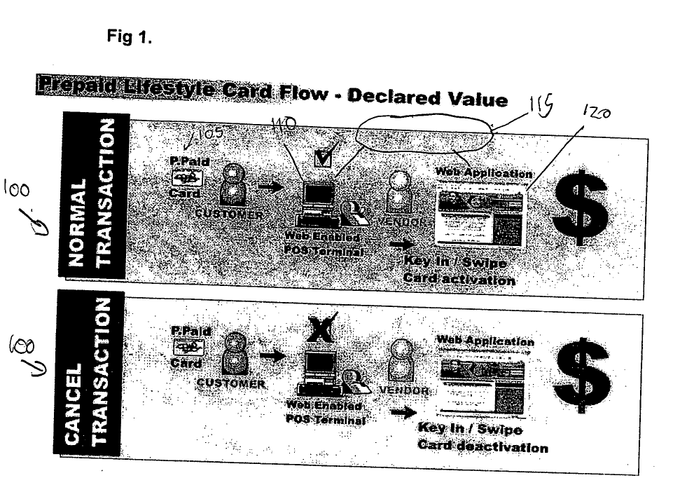

Referring to the drawings wherein like reference numerals designate corresponding parts throughout the several figures, reference is made first to FIG. 1 that illustrates an embodiment of a prepaid dating system 100 for a user to purchase and activate prepaid dating cards. In general, the system 100 includes a prepaid dating card 105 for interacting with a merchant terminal 110 for activation and value insertion of funds for later redeemable use for dating services, typically online dating services on a network 115. The merchant terminal 110 can typically be a point of sale (POS) terminal that is connected to the network 115, such as the Internet. In a typical implementation, the dating services are provided by a service provider having a presence on the network 115, such as through a web application 120. Typically, as described further below, the prepaid dating card 105 is activated (or deactivated) by conventional key-in or swipe methods.

Therefore, in a typical embodiment, various pre-existing and proven technologies can be used to empower the prepaid cards 105. For example, the prepaid dating card 105 can include a magnetic strip as a readable medium including the value insertion data. A standard card with data encoded in the ISO8583 (1987) format readable by any POS system, such as the merchant terminal 115, can be implemented. In another embodiment, a unique buyer identification number (BIN) such as a “6” series BIN can be used for identification purposes. In general, the system 100 can include an activation and tracking interface that can be a proprietary web application on network 115 having several actions including but not limited to: activation, thereby making the prepaid dating card 105 active; cancellation, thereby canceling the activation of the prepaid dating card 105; returning unused prepaid cards 105, thereby refunding any balances of prior value insertion if the prepaid dating card 105 is unused; and redemption, which provides automatic value reduction of the prepaid dating card 105 as services are rendered.

In an initial process flow of the system 100, for example, for fixed value prepaid dating cards 105 that come in pre-selected denominations, a proven existing model, such as the model for prepaid phone card, can be advantageously implemented. In a typical embodiment, the prepaid dating card 105 is manufactured and packaged in a disabled, non-activated state. The prepaid card can include one or more form factors for a readable medium having data, such as magnetic strips, bar codes, numeric codes and the like. The prepaid card can be displayed at a retailer and selected by a customer. When the prepaid dating card 105 is scanned or swiped or other wise interacted to access and activate the readable medium, the prepaid dating card 105 is activated. Alternatively, the retailer or merchant can enter the card number or other unique code into a web portal to access the network 115. Alternatively, any other suitable channel can be implemented for activation. IN another implementation, when the prepaid data card 105 is activated by UPC scanning, the receipt that is generated can include an activation code that can be subsequently manually entered by the user. The process can include individual store maximums that can be set to avoid theft of activated prepaid cards 195, and the prepaid cards 105 can typically be only activated by employees of the particular retailer location. This control feature allows limitation of the exposure and liability of individual shop owners. The consumer can then use the card based on T & C. In the event of a cancellation of the transaction, the prepaid dating card 105 can be re-swiped, or otherwise deactivated, the disable it again.

In general, network processing is implemented by tying into existing prepaid infrastructures for transaction processing. In other implementations, non-transferable, non-currency value attached to the prepaid dating card 105 such as months of dating site membership can be the value that is inserted into the prepaid dating card 105. In one implementation, debiting works as whole number transactions data associating how much value is left on the prepaid dating card 105 is centralized in a local network. Typically, authorizations come from back ends of the local network and are evidenced by the unique BIN. In a web application option, an interface is provided allowing store locations without the proper connections to still sell the prepaid dating cards 105 by using the web interface for activation. In another implementation, for cards that are already activated, a PIN can be used. In general, the merchant has previously received PIN numbers within their database and prints the activation instructions and PIN number on the receipt at time of purchase.

The system 100 and users of the system 100 typically implement any number of redemptions models that can be of general or typical use. A user at any time can go to the network 115 or use phone chat lines (interactive voice response (IVR)/multimedia messaging system (MMS)/wireless application protocol (WAP)/short message service (SMS) and the like) and be served a payment prompt. At that time, the user typically elects the prepaid dating card 105 option. At that time, the card number is entered, followed by entering an X digit personal identification number (PIN). Typically, a form is populated and submitted for membership. At any time, the prepaid dating card 105 holder can use the IVR number on the back of the prepaid dating card 105 with using the PIN for access to included minutes for web, phone, mobile or any other dating service, or social networking and community services, including but not limited to IE jobs, blogs and the like. Any combination of redemption changes the status on the prepaid dating card 105 invalidating it for any refund at the POS. Therefore, the prepaid dating card 105 provides any number of form factors for redemption including, but not limited to chat time, network access to any number of online dating portals, phone minutes and the like. In a typical embodiment, there are three desirable channels of use. 1) the Internet, in which a user logs onto a particular site, chooses a prepaid dating card 105 option, enters a X digit number for log on. In one implementation, the prepaid dating card can include an IP address identifier (IP look up) that helps determine geographic location such that users will be geographically close to other users in case the users actually want to meet and interact. 2) Chat/Text messaging that provides access to text members, a short call number can be entered, then an access code. By using triangulation or global positioning system (GPS), and/or IP identifier, proximate other users can be located. The triangulation or GPS allows suitable text and phone members to be brought together via this or other form factors. In general, a combination of tracking is generally needed if an Internet user is talking to a mobile customer via voice over Internet Protocol (VOIP) or text messaging, for example. Furthermore, caller Ids can be seamless implemented to allow proper geographical locations. 3) Interactive Voice Response (IVR) can be implemented by simply entering the IVR number and performing a reverse look up for suitable users. In general, the channels as described can allow identification by geographic region to find appropriate local chat rooms, thereby forming appropriate prepaid dating networks.

There are many systems and methods in which the embodiments of the prepaid dating card can be implemented. An example of such systems and methods that offer management of a network or online personal sites in various niche markets and provide portal solutions allowing other websites to manage online portals are now described. Quick introduction of niche and specific portals are possible resulting in quick saturation of niche markets. Sites, whether dating, gaming or other paradigms work very similarly. A member enters their information and searchers for a match based upon their personal preferences. Several media including video chat, member voice mail SMS, cell phone dating, traditional chat rooms and the like can be quickly implemented in any given portal/site development. A portal development wizard can be used to rapidly implement and customize a portal using a application service provider based model of saving customized values and serving the same values accordingly providing a unique user interface and experience.

As further discussed in the description below, the basic steps include: choosing a site template from a bank of templates available or custom creating and uploading template values; configuring style sheet values using an HTML editor or style sheet wizard; providing site related information as the tag line, site name and the like; submitting data filters segmenting demographic, lifestyle and activity based information; uploading site logo and add site text; adding metadata; and adding affiliate banners, text links and the like.

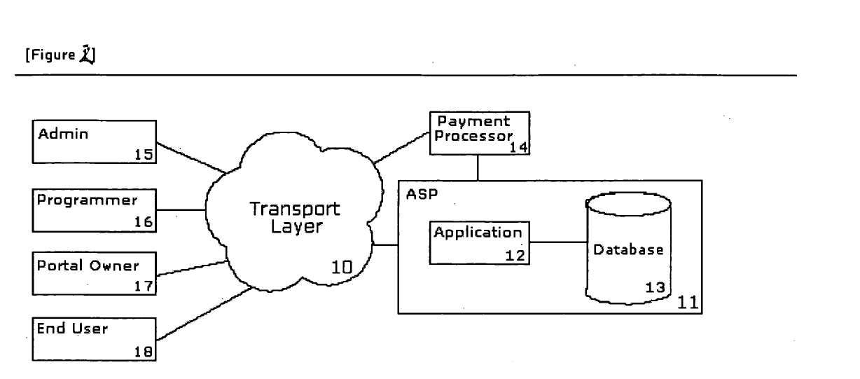

FIG. 2 illustrates an embodiment a network in which an embodiment of architecture can be used is shown to have an admin group 15, a programmers group 16, and a portal owner 17 is able to have a session with the application 12, through a transport layer 10. They are all able to use the application 12 and database 13. An end user 18 can have a session with the portal owner's application. Any transactions that take place are handled by a payment gateway 14.

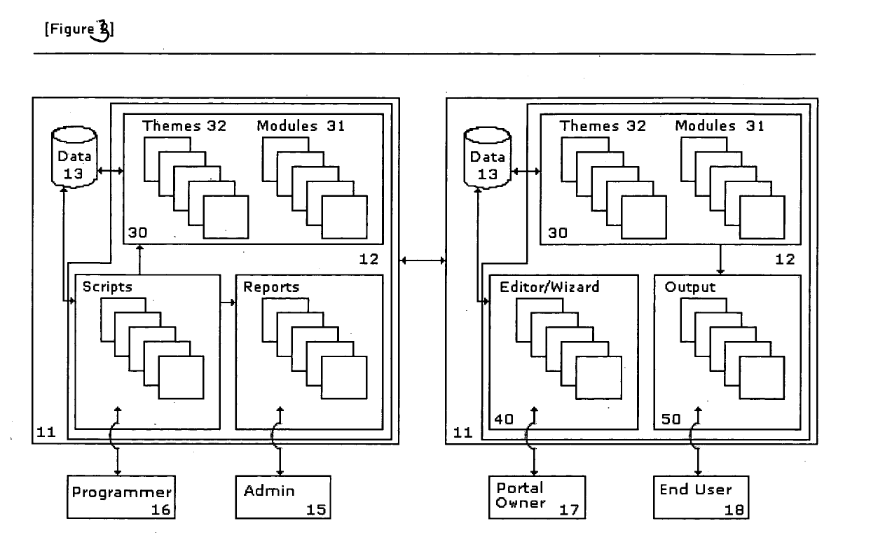

FIG. 3 illustrates an exemplary components that can be included. A programmer group 16 is able to store a set of tools in the form of utilities or files on the Application to build or edit the modules stored for use. Each of the modules is comprised of program code that is generated by the programmer 16 that resides on the ASP 11 and is deployed to the application layer 12 when updates occur. Each of the modules The Admin group 15 is able to use a set of tools that enables them to view reports of the system. The portal owner group 17 is able to access a set of tools known as a wizard 40 that grants access to reports and will allow them to edit/create an application. The end user group 18, is able to view the output created by the application. As described above, the program code could be any code that is used to perform any function or represent a set of visual attributes, and the present invention is not limited to the provision of any particular code. In a typical implementation, the programmer group is able to make updates and patch an Application Service whenever necessary following a controlled versioning system.

When a portal owner interacts with the output builder 40 they first select the type of product/service they are building, in many cases this is site specific. For example, http://www.DateApp.com only creates dating sites, thus the product/service module is predetermined within the site builder application. Each product/service module 31 has an associated content server that connects the associated database with the product or service being offered. Through the GUI the client chooses the attributes associated with the product to include the functional modules 31 and skin modules 32. Dependant upon the product/service initially selected, various commission or product pricing levels may be selected. The administration module is generated based upon the site or sites created. The Portal Owners Output 50 is shown which includes modules that have been forwarded to the output upon the portal owners' selection.

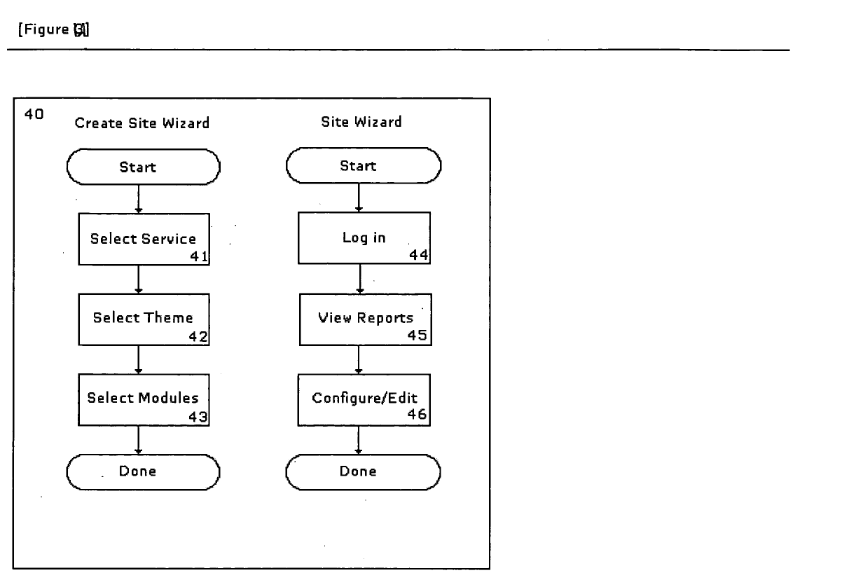

FIG. 4 illustrates an embodiment of an exemplary components that can also be included. An example of how a portal owner can use the Wizard 40. The portal owner 17 can select a product/service module 41, for example it may be a dating portal. Next, they select colors and themes 42 for the application. In completion the portal owner browses add-ons in the form of modules 43. The portal owner can select modules and save their settings. When a Portal Owner returns to an application, the portal owner is able to login 44, view reports 45, and configure and edit 46 the application.

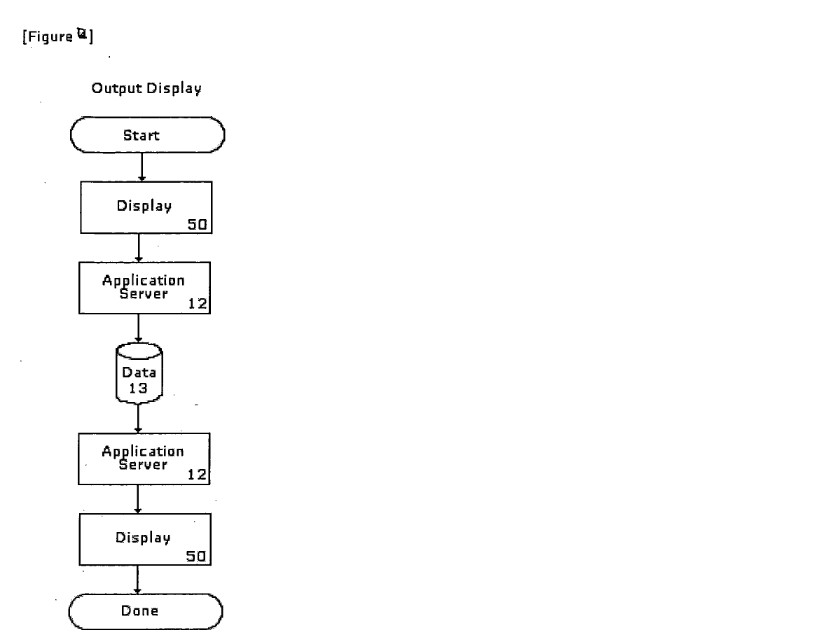

FIG. 5 illustrates an exemplary components that may be included. Output is displayed 50 when a end user interacts with the application. The Application 12, will make a Read or Write request from the Database 13, and the new output will formatted by the Application Server 12 to be displayed 50 for the end user 18.

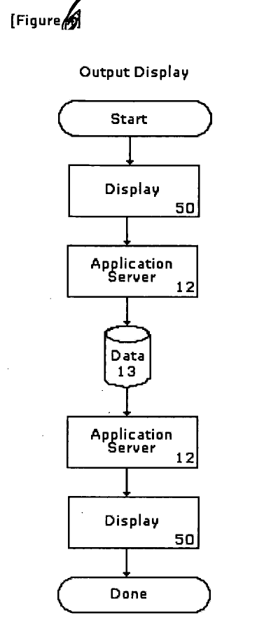

FIG. 6 illustrates an embodiment of a block diagram illustrating exemplary components that display work flow to an IVR or SMS service.

In an embodiment of the systems and methods described above, a modular site design system can be developed that generally includes a number of design modules, an interface enabling selection that is coupled to the design modules. In general, a user can use one or more subsets of the design modules of the number of design modules to be included in a electronic presence. The selected design modules generally form a package of design modules. The system can further include one or more devices or other means for forwarding the package of design modules to a the application service provider platform and deployment onto a electronic medium.

In a typical implementation, the modular site design system, typically include a plurality of design modules that include visual modules and functional modules. Furthermore, the interface is a graphical user interface. In addition, the design modules typically include a parse tool to display various attributes of the database to the portal owners' end users. In addition, the design modules include administration modules for administering the Portal Owners electronic presence.

In general, the design modules can be used for a variety of purposes including but not limited to video on demand, video on demand, syndicated content, financial services, sports, social networking, advertising, gaming, lead generation, shopping, syndicated broadcasts, communications, community services, blogging, remote operation of a mechanical object, tracking, military use,

In general, the application service provider platform owns and operates a software application and typically operates and maintains the servers that run the application. In addition the application service provider platform makes the application available to the portal owners via an electronic platform, either in a browser or through some sort of “thin client”. In general, the application owns all the data gathered through its interaction with the portal owners end users.

In another embodiment, the systems described herein can include a method for designing and deployment of an electronic presence for a portal owner including the steps of selecting a design module, database inclusions, database filters, and/or inclusions of various product service offerings from a plurality of design modules at a graphic user interface and forwarding the design module which resides on Application Service Provider platform for electronic publishing.

In a typical implementation, the design module is a graphical user interface or alternatively, a functional module that affects design, product, service, workflow, and database properties.

In addition, the deployment of an electronic can include a variety of devices including, but not limited to a web browser, a mobile device, a PDA, an IPOD, PSP, a PS2, a cellular phone, a storage device, a mobile device, a prepaid device and a mechanical device.

In general, in another implementation, the application service provider platform acts as a depository and retains all end user data of the portal owner. In addition, the database inclusions can be used to select a variety of components including but not limited to various product offerings, templates, cascading style sheets, template attributes, language attributes, member demographics, meta data, RSS feeds and deployment type.

In general, in another embodiment, a modular portal owner design system is contemplated wherein a resulting electronic presence includes a plurality of linked modules and a method for updating one of the modules including forwarding an updated version of one of the modules to an application service provider using the one of the modules, storing, at the application service provider, the updated version of the one of the modules, replacing, in a directory structure at the application service provider, a first pointer to an existing version of the one of the modules with a second point to the updated version of the one of the modules.

In a specific implementation, of the systems and methods described herein, multiple dating websites can be developed, having access to a common database of members having access to the dating websites. The members may have chosen to be a member of one or more of the websites. However, in a typical implementation, they have become members of all of the websites. As such, each of the members has the potential to contact one another depending on the criteria that they have chosen in their particular website interface. In general, the members have seamless access to a components database. By choosing interface criteria, such as interests, sexual orientation race and the like, a filter is created from a subset of the pre-selected criteria of the components database. Therefore, as the filter is built, the member limits the types of members of the larger populated database to create a subset of the database in another shared interest database. By making this selection, the member has access to other members who have common criteria. Once this selection is created, the member can contact other members through, for example, chat rooms and be able to become more intimately knowledgeable of particular members of interest. From this point, the members can choose how they want to potentially meet each other or make other arrangements of communication.

Therefore, a single dating portal can be easily created. Several portals or websites can be created and managed across several networks containing different sets of members, but optionally all having access to the larger populated database. From a single domain, a webmaster can create a theme to match multiple websites and brandings, whether the site members are looking for love, a friend, a certain lifestyle, sexuality or geographic region. The portal can therefore provide a customized database to meet whatever the members' needs. Any given member can choose from fields in the interface that are interchangeable and have potentially infinite iterations. For example, the fields can be chosen from relationship type, activity, lifestyle and location, which equal a niche community. A more specific example of chosen fields can be friends, movies, straight and New York, which results in a site for heterosexual movie-goers in New York. It is now appreciated that the fields are linked directly to the components database for use in creating the filters as described above. The use of customized, or shared, databases as described above provides a send of community and raises the webmaster's conversion rate, that is, paid memberships, and retention, that is, the time being a paid member.

In general, the features described above provide systems and methods that include content management capability. Due to the described flexibility of the development and the multiple networks available, the system provides ability to add content to individual sites as well as available content. In general, the sites can be modified in a large variety of ways, including but note limited to customizing a database to clientele to target a certain end user, custom templates, front page text, metadata/header, calendar ability, articles, links and discussion boards. Site features can include but are not limited to user experience, typically including ease of navigation and encouragement of upgrades; internal member email that is secured real time delivery with spam protection; video/text chat with full bandwidth with voice and picture in real time; telephone voice mail/call forward without having to give out a real telephone number; cell phone dating with SMS, WAP and MMS; offline venues for safe haven to meet, mix and mingle; multiple membership levels; generic customer service; multiple payment options; advertising engine implementation; global payment options and affiliate/sub-affiliate/MLM programs.

It is contemplated that the subsets of criteria that a user forms to create have access to a shared database can be accessible to a plurality of devices, similar to as described above. These devices can include, but are not limited to a web browser, a mobile device, a PDA, an IPOD, PSP, a PS2, a cellular phone, a storage device, a mobile device, a prepaid device and a mechanical device. In a typical example, a user may want to access the information via a cellular phone. In such an example, the user may want to travel from his/her home state to another state. As such, the criteria can be set and locating systems such as GPS or triangulation systems can be employed to sense the cell phone and immediately apply the criteria to the new geographic location, thereby providing immediate access to other users in the area.

In general, it is appreciated that the systems and methods described herein allow users to access a variety of electronic social communities. The embodiments that have been specifically described have included dating online. However, it is appreciated that the systems and methods include other social interactions, communities, etc. In addition, many other mediums other than online, are contemplated such as interactive voice response IVR/MMS/WAP/SMS and the like. It is further understood that the systems and embodiments described herein can be used for other prepaid services such as for gambling sites, prescription sites and the like. Furthermore, the prepaid cards can be as-you-go cards or even single use cards.

The following description discusses specific examples of how the systems and methods herein can be implemented for prepaid card distribution and activation.

In general there are several types of prepaid cards that can be implemented, including but not limited to: electronic gift cards; incentive cards; loyalty cards; mall cards; medical & FSA cards; payroll cards; prepaid phone cards; prepaid-wireless; and promotional cards. In addition, there are many program participants including a master distributor who sells to other sub-distributors and can operate an agent program directly for a reseller. The master distributor usually makes a volume commitment but is not responsible for billing and collections. A sub-distributor could be a card provider Distributor. Distributors are the conduit between the manufacturer and the retailer. Distributors assist prepaid product producers by introducing them to a wide range of outlets to sell their products who typically provide PINs or point of sale activation (POSA), card distribution, authorization, clearing, and/or settlement services for merchants, and who can provide POSA message or data to the card provider and contracts with Company. A company is an entity that owns one or more merchant retail locations and can be the contracting entity for Card provider or the Distributor. A merchant is retail entity that sells Card provider Products (Cards or PINS). (Retailer, store, etc.). Provide POSA message or data to Distributor or Date App. A partner is an entity whose content is marketed through card provider and that accepts card provider products (cards or PINS) in payment for merchandise or services, and processes the requests.

In general, for a merchant at the point of sale, the sales clerk initiates a prepaid transaction as follows: takes a card from a consumer; scans a UPC Code (Card or laminated sheet); tenders cash; and begins activation by passing the card through a reader to electronically capture information and sends to POSA company or directly to Card provider. The merchant can also optionally enter the amount of the transaction. The card activation is either authorized or declined, and the merchant can print a transaction receipt. (with PIN). In general, at that point, the consumer leaves with Activated Card (or PIN).

An embodiment of the prepaid program utilizes the card provider authorization and payment infrastructure to deliver transactions to and from participants. Merchants can utilize the same authorization equipment through their POSA Company (or come directly to Card provider) in message formats currently in place to delivery Card provider transactions. The types of transactions can include prepaid transaction requests that can be supported through merchants include but are not limited to: card Activation without load; activation with initial load; reloading of Card; return of merchandise; balance inquiry; stored value purchase; voids are also supported; PIN request (typically PINS are delivered to batch to POSA distributor); and PIN delivery (typically PINS are delivered to batch to POSA distributor).

With point-of-sale delivery, cards are typically not required for the sale of a product. PINs (product identification numbers “PINs”) are sent to the delivery device and printed on register or terminal receipts. The customer then follows the instructions on the receipt and contacts Card provider designated redemption portal to activate and/or redeem their PIN. Point-of-sale delivery of PINs is available for our full range of products. More products and more choices lead to increased customer satisfaction and revenue. Point-of-sale delivery of PINs allows products to be delivered to multiple devices, including terminals, register systems and kiosks. This allows retailers to remain flexible across the chain and helps retailers maintain a competitive edge by offering the most customer-friendly product delivery.

Point-of-sale activation (POSA) involves cards that do not have a value until activated through the register or terminal. Therefore, POSA cards can be displayed with no worries of theft. The customer chooses the product card for purchase, and the retailer activates it upon payment. POSA products can be merchandized with great impact and provide a streamlined transaction process for Card provider, the Merchant and the customer.

The card provider has the capability for real-time replenishment making the purchasing process simple and effective for both the customer and the merchant. Real-time replenishment allows for immediate account replenishment by card provider connecting directly into a POSA Company or directly to a Merchant. This feature enables merchants to quickly and easily add money, time or credit to a customer's card, without requiring a secondary phone call or a provider hard card to replenish an existing card.

In general, for activation of hard card POSA, the card is swiped at Merchant POS and is routed to POSA Distributor or Provider Host. The POSA Provider validates card and relays transaction. The POSA Provider receives (authorized/declined) message from the card provider and sends it to the merchant. The card provider sets card to active status and card is retailer activated for pre-set dollar amount. The POSA Provider updates card inventory records. The card provider updates card inventory records. Authorization is sent back to Merchant and receipt is printed. The card is now active and ready for redemption.

For activation using a PIN, the POSA provider receives PIN batch from the card provider. The PIN is requested at merchant POS and is routed to POSA distributor or provider host. The POSA provider receives PIN request from the merchant. The PIN is sent back to the merchant and a receipt is printed. The PIN is now active and ready for redemption. The POSA provider sends the car provider a batch of all activated PINs.

Settlement through card provider includes a series of steps. For Stored Value transactions authorized by participating entities at the end of the day: the card provider settles with POSA Providers and POSA Providers settle with their merchants. There are also POSA settlements through the card provider and PIN settlements through the card provider. In general there is an overall reconciliation process. Reconciliation is a process that compares data from different sources, local log records (e.g. merchant or POSA logs) and data from the system of record (e.g. Card provider), to ensure transactions have been properly counted and processed. Reconciliation is used to: validate daily settlement with the daily account funding position for merchants and POSA providers; identify differences between the merchant's t transaction records, the POSA provider and Card provider's transaction record to highlight exceptions; match information about each transaction from both sources of data; identify transactions that require further research; and manual adjust the transactions as necessary.

In general for the POSA reconciliation process, the POSA provider POSA activates cards on a daily basis and sends the card provider a daily sales file of all POSA cards with other transaction information. For example, a CSV file can be sent daily via secure FTP process. The card provider follows internal reconciliation process: compare or “bash” POSA provider's daily sales file with Card provider data base of POSA card activations: identify differences between the merchant's transaction records, the POSA provider and card provider's transaction record to highlight exceptions; match information about each transaction from both sources of data; and identify transactions that require further research. In general, adjustments are manual and the companies can trade reconciliation files for hard card POSA activation and then reconcile

For the PIN reconciliation process, the POSA provider generates PINs on a daily basis. The POSA provider sends Card provider a daily sales file of all generated PINs with other transaction information, which can be a CSV file sent daily via secure FTP process. The card provider follows internal reconciliation process: compare or “bash” POSA provider's daily sales file of PINs issued with card provider data base of Overall PIN batch send to POSA provider; identify differences between the POSA provider issued PINs and Card provider's transaction record to highlight exceptions; match information about each transaction from both sources of data; and identify transactions that require further research. In general, Adjustments are manual

There are different requirements for the different participants. At the time a POSA Provider requests Prepaid cards from Card provider, Card provider needs to determine: which service options will be used; what third party processor (if any) will be used; the financial Viability of POSA provider; technology needed to support; implementation timelines; and strategic fit. In a typical implementation, the POSA provider must: receive and respond to transaction sets-ISO message formats; receive settlement via card provider; process voids and reversals if supported; provide back office support for exceptions; have a legitimate card distribution network and existing PIN or POSA; manage acceptance locations through the use of unique merchant identifiers to ensure transactions originate from specific locations; designate a bank account where electronic funds can be deposited; certify with its merchant(s) and Card provider.

In general, the merchant will need to: send and receive transaction sets; develop a point-of-sale application that supports POSA Provider transaction set; have terminals at the point of sale that can identify Pre Paid programs, print a sales draft receipt, and initiate voids, if appropriate; and work with the POSA provider to agree on the settlement process and reconciliation procedures for Prepaid transactions

In general, the card system can include functionality including, but not limited to: login; logout; add distributor; edit distributor; remove distributor; disable distributor; remove distributor; add product; edit product; remove product; disable product; add company; edit company; remove company; disable company; enable company; add product to distributor; remove product from distributor; add product to company; remove product from company; add product to merchant; remove product from merchant; generate cards; create; edit emission; disable emission; remove emission; enable emission; start cards generation; upload order; obtain order; start order obtain; stop order obtain; and send cards.

The software techniques and methods discussed above can be implemented in digital electronic circuitry, or in computer hardware, firmware (as discussed), software, or in combinations of them. Apparatus may be implemented in a computer program product tangibly embodied in a machine-readable storage device for execution by a programmable processor; and methods may be performed by a programmable processor executing a program of instructions to perform functions by operating on input data and generating output. Further embodiments may advantageously be implemented in one or more computer programs that are executable on a programmable system including at least one programmable processor coupled to receive data and instructions from, and transmit data and instructions, to a data storage system, at least one input device, and at least one output device. Each computer program may be implemented in machine language or assembly language which can be assembled or translated, or a high level procedural or object-oriented programming language, which can be complied or interpreted. Suitable processors include, by way of example, both general and special purpose microprocessors. Generally, a processor receives instructions and data from read-only memory and or RAM. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing may be supplemented by, or incorporated in, specially designed application specific integrated circuits (ASICs).

The foregoing is considered as illustrative only of the principles of the invention. Further, various modifications may be made of the invention without departing from the scope thereof and it is desired, therefore, that only such limitations shall be placed thereon as are imposed by the prior art and which are set forth in the appended claims.

What is claimed is:

1. A prepaid social community system, comprising:
a central server connected to a network;
at least one dating service provider connected to the network;
at least one merchant terminal connected to the network;
a prepaid dating card for interacting with the at least one merchant terminal to receive a value insertion from the at least one merchant terminal, and for interacting with the at least one dating service provider that extracts value from the prepaid dating card in return for dating services provided by the at least one dating service provider.

2. The system as claimed in claim 1 wherein the dating service provider is a web portal developed from a modular site design system, including:
a plurality of design modules;
an interface for selecting a subset of the design modules of the plurality to be included in an electronic presence, the selected design modules forming a package of design modules;
means for forwarding the package of design modules to a the application service provider platform and deployment onto a electronic medium; and
means for accepting the prepaid dating card as payment for access to the web portal.

3. The system as claimed in claim 1 wherein the dating service provider is a web portal comprising:
an interface formed by a design module;
membership database inclusions in the interface from which individual members can choose;
database filters created by individual users of the web portal to select users of interest based on pre-selected criteria; and
a payment option for membership to the web portal.

4. The system as claimed in claim 3 wherein the payment option is the prepaid dating card.

5. The system as claimed in claim 3 wherein the web portal further comprises inclusions of various product service offerings from a plurality of design modules at a graphic user interface.

6. The system as claimed in claim 3 wherein the web portal resides on an application service provider platform for electronic publishing, thereby advertising a payment option using the prepaid dating card.

7. The system as claimed in claim 1 further comprising a plurality of linked modules creating an electronic presence, the linked modules all for receiving payment from the prepaid dating card as a form of payment for access to the modules.

8. The system as claimed in claim 7 wherein the dating service provider is one of the plurality of linked modules.

9. The system as claimed in claim 8 wherein the modules can be updated by forwarding an updated version of one of the modules to an application service provider using one of the modules, storing, at the application service provider, the updated version of the one of the modules, replacing, in a directory structure at the application service provider, a first pointer to an existing version of the one of the modules with a second pointer to the updated version of the one of the modules.

10. The system as claimed in claim 9 wherein data related to the prepaid dating card can be updated in one or more of the plurality of modules.

11. The system as claimed in claim 10 wherein data related to the prepaid dating card is value inserted into the prepaid dating card.

12. Data residing on a readable medium capable of receiving instructions comprising:
receiving and retaining payment data;
providing the payment data to a central location;
associating the payment data with pre-selected dating-related services; and
reducing the payment data based on usage of the payment data related to the dating-related services.

13. The data as claimed in claim 12 wherein the readable medium is a bar code.

14. The data as claimed in claim 12 wherein the readable medium is magnetic media.

15. An article of manufacture, comprising:
a main body; and
a readable medium on the main body, the readable medium having data related to pre-payment of funds to be used for dating services.

16. The article of manufacture of claim 15 wherein the readable medium is a magnetic strip.

17. The article of manufacture of claim 15 wherein the readable medium is a bar code.
